(19) United States
(12) Patent Application Publication
(10) Pub. No.: US 2013/0051644 A1
(43) Pub. Date: Feb. 28, 2013

(54) METHOD AND APPARATUS FOR PERFORMING MOTION ARTIFACT REDUCTION

(71) Applicant: BRIAN EDWARD NETT, MADISON, WI (US)

(72) Inventor: BRIAN EDWARD NETT, MADISON, WI (US)

(73) Assignee: GENERAL ELECTRIC COMPANY, SCHENECTADY, NY (US)

(21) Appl. No.: 13/220,166

(22) Filed: Aug. 29, 2011

(51) Int. Cl. G06K 9/00

(52) U.S. Cl. 382/131

(57) ABSTRACT

A method for reconstructing an image of an object having reduced motion artifacts includes reconstructing a set of initial images using acquired data, performing a thresholding operation on the set of initial images to generate a set of contrast images that identify areas of contrast from which motion artifacts originate, transforming the thresholded images into a conjugate domain, combining the conjugate domain representations of the contrast images, transforming the combined conjugate domain representations to an image domain to generate a residual image, and using the residual image to generate a final image of the object.

### BACKGROUND OF THE INVENTION

This subject matter disclosed herein relates generally to imaging systems, and more particularly, to a method and apparatus for performing artifact reduction using an imaging system.

Non-invasive imaging broadly encompasses techniques for generating images of the internal structures or regions of a person or object that are otherwise inaccessible for visual inspection. One such imaging technique is known as computed tomography (CT). CT imaging systems measure the attenuation of x-ray beams that pass through the object from numerous angles. Based upon these measurements, a computer is able to process and reconstruct images of the portions of the object responsible for the radiation attenuation. CT imaging techniques, however, may present certain challenges when imaging dynamic internal organs, such as the heart. For example, in cardiac imaging, the motion of the heart causes inconsistencies in the projection data which, after reconstruction, may result in various motion-related image artifacts such as blurring, streaking, or discontinuities. In particular, artifacts may occur during cardiac imaging when projections that are not acquired at the same point in the heart cycle, e.g., the same phase, are used to reconstruct the image or images that comprise the volume rendering.

For example, in CT reconstruction the image function to be reconstructed, f(x, y, z), is generally assumed to be stationary during the acquisition. However, because the image function is a function of time as well, f(x, y, z, t), motion related artifacts become apparent in the reconstructed images. Motion compensation techniques have been developed which estimate the time dependent changes and account for these time dependent changes in the reconstructed images. However, conventional motion compensation techniques are computationally intensive. Accordingly, at least one known motion compensation technique identifies the coronary arteries and corrects only the motion near the coronary arteries. However, residual motion artifacts adjacent to the cardiac chambers may also exist. For example, residual motion artifacts may be caused by, for example, the rapid deformation of the left ventricle (LV) during the image acquisition procedure. Because the image contrast in the LV is significantly greater than the surrounding myocardium, these residual motion artifacts may result in false hyper-attenuation and/or hypo-attenuation in the myocardium image.

### BRIEF DESCRIPTION OF THE INVENTION

In one embodiment, a method for reconstructing an image of an object having reduced motion artifacts is provided. The method includes reconstructing a set of initial images using acquired data, performing a thresholding operation on the set of initial images to generate a set of contrast images that identify areas of contrast from which motion artifacts originate, transforming the thresholded images into a conjugate domain, combining the conjugate domain representations of the contrast images, transforming the combined conjugate domain representations to an image domain to generate a residual image, and using the residual image to generate a final image of the object.

In another embodiment, an imaging system is provided. The imaging system includes a detector array, and a Motion Evoked Artifact Deconvolution (MEAD) module coupled to the detector array. The MEAD module is configured to reconstruct a set of initial images using acquired data, perform a thresholding operation on the set of initial images to generate a set of contrast images that identify areas of contrast from which motion artifacts originate, transform the thresholded images into a conjugate domain, combine the conjugate domain representations of the contrast images, and transform the combined conjugate domain representations to generate a residual image, and use the residual image to generate a final image of the object.

In a further embodiment, a non-transitory computer readable medium is provided. The non-transitory computer readable medium is programmed to instruct a computer to reconstruct a set of initial images using acquired data, perform a thresholding operation on the set of initial images to generate a set of contrast images that identify areas of contrast from which motion artifacts originate, transform the thresholded images into a conjugate domain, combine the conjugate domain representations of the contrast images, and transform the combined conjugate domain representations to generate a residual image, and use the residual image to generate a final image of the object.

### BRIEF DESCRIPTION OF THE DRAWINGS

FIG. 1 is a flowchart of an exemplary method for reconstructing an image of an object in accordance with various embodiments.

FIGS. 2A and 2B are pictorial representations of the method illustrated in FIG. 1.

FIG. 3 is a visual representation of an exemplary set of projection data that may be acquired in accordance with various embodiments.

FIG. 4 is plurality of images formed in accordance with various embodiments.

FIG. 5 is a flowchart of another exemplary method for reconstructing an image of an object in accordance with various embodiments.

FIG. 6 is plurality of final images formed in accordance with various embodiments.

FIG. 7 is a pictorial view of an exemplary multi-modality imaging system formed in accordance with various embodiments.

FIG. 8 is a block schematic diagram of the system illustrated in FIG. 7.

### DETAILED DESCRIPTION OF THE INVENTION

The foregoing summary, as well as the following detailed description of various embodiments, will be better understood when read in conjunction with the appended drawings. To the extent that the figures illustrate diagrams of the functional blocks of the various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

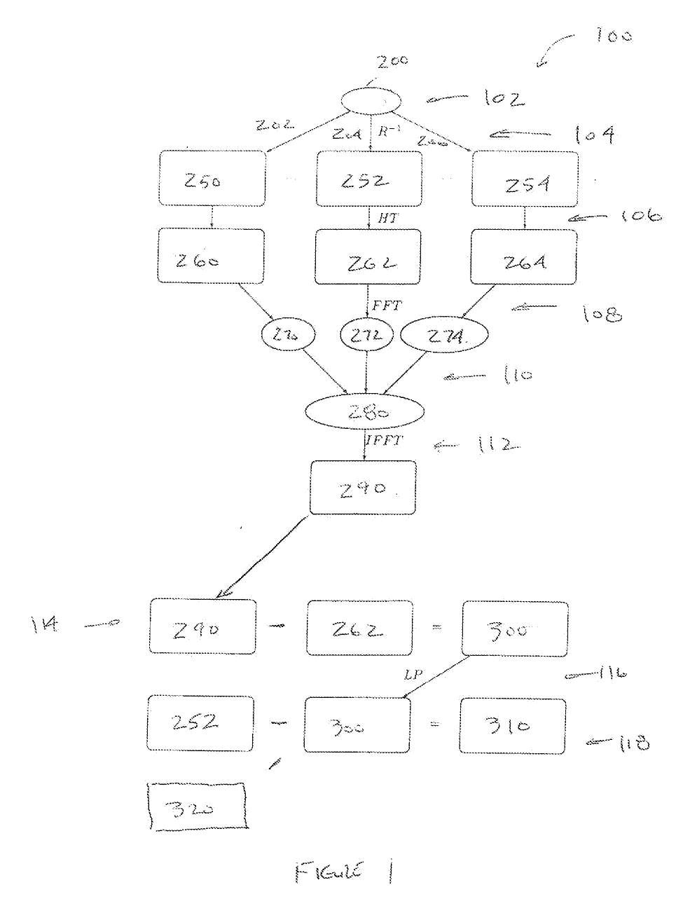

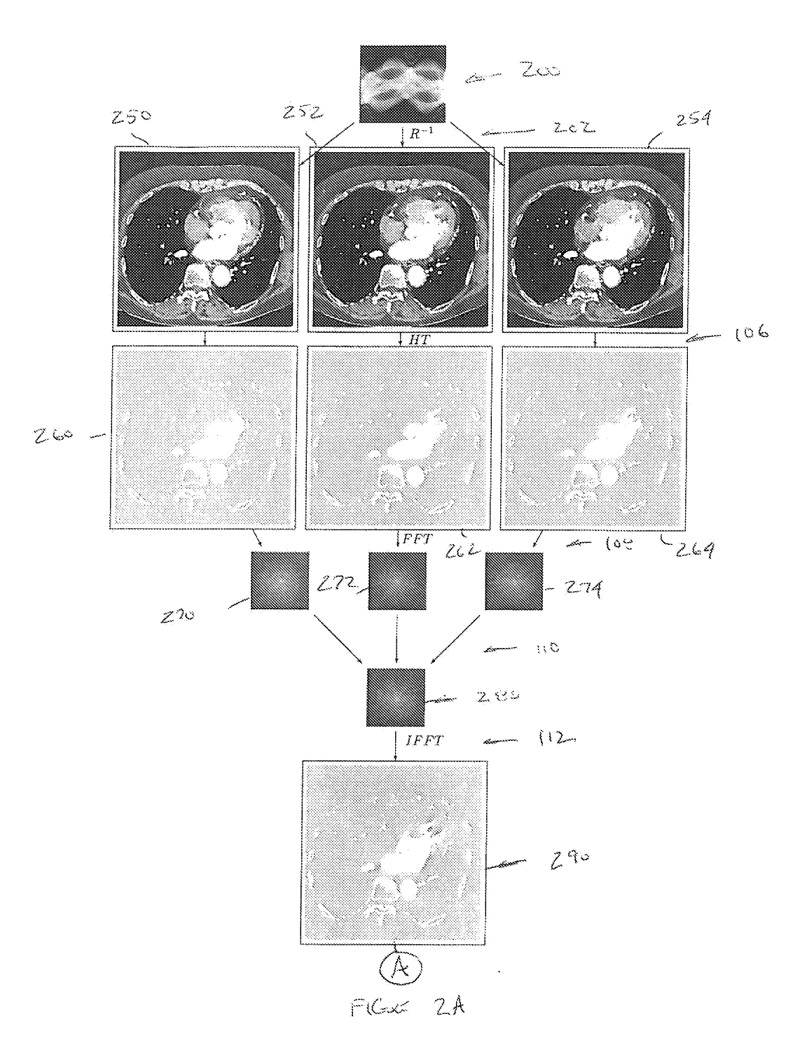

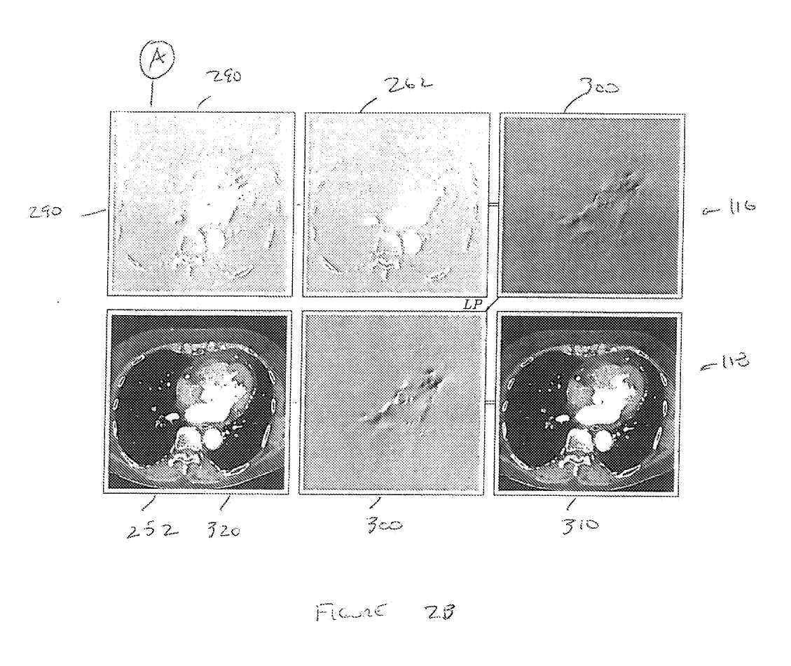

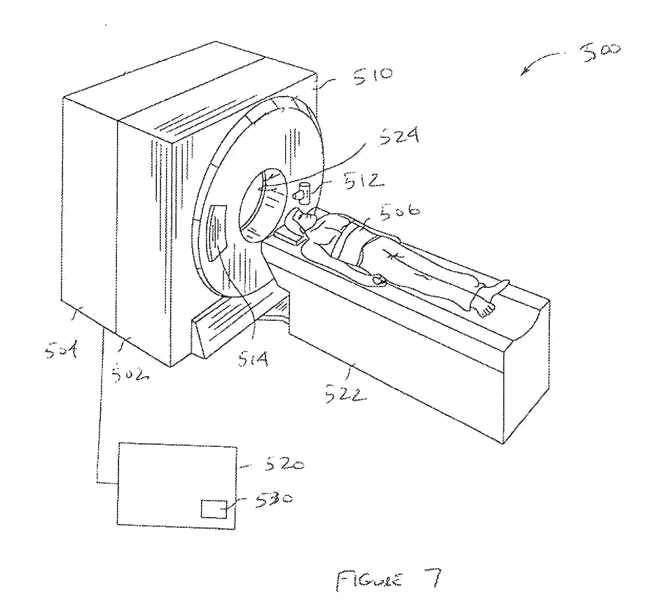

FIG. 1 is a flowchart of an exemplary method 100 for reconstructing an image of an object. In the exemplary embodiment, the method 100 is used to reconstruct an image of the heart of a subject, such as subject 16 shown in FIG. 7, having reduced motion artifacts. FIGS. 2A and 2B are a pictorial representation of the method 100 shown in FIG. 1. The method 100 may be embodied as a set of instructions that are stored on a computer and implemented using, for example, a Motion Evoked Artifact Deconvolution (MEAD) module 530, shown in FIG. 7 that is configured to implement various motion compensation methods described herein.

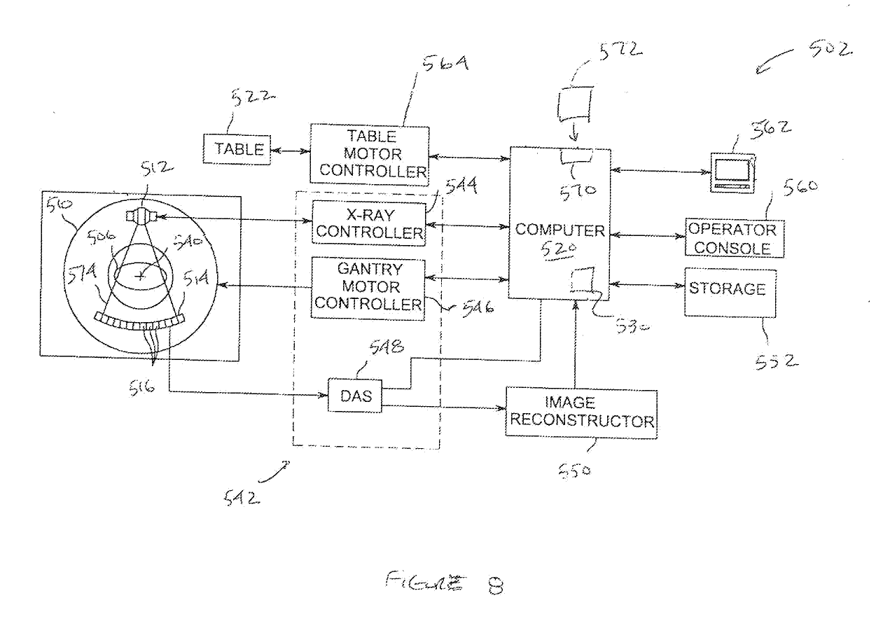

Referring to FIG. 1, at 102 a subject is scanned to generate a set of data. In the exemplary embodiment, the set of data is a set of projection data 200 acquired using the CT imaging system shown, for example, in FIGS. 7 and 8 which are discussed in more detail below. Optionally, the set of data may be acquired using other imaging systems described herein. The projection data 200 may be acquired from less than a full scan of data, thereby minimizing exposure of the object to radiation administered during the scan. The projection data 200 may also be acquired using a half-scan to acquire projection data from an angular range of at least 180 degrees plus a fan angle of an x-ray source. In the exemplary embodiment, the fan angle may be, for example, 60 degrees, such that the total range scanned is approximately 240 degrees. However, it should be realized that different systems may have different fan angles, and therefore the scan angle of 240 degrees is exemplary only.

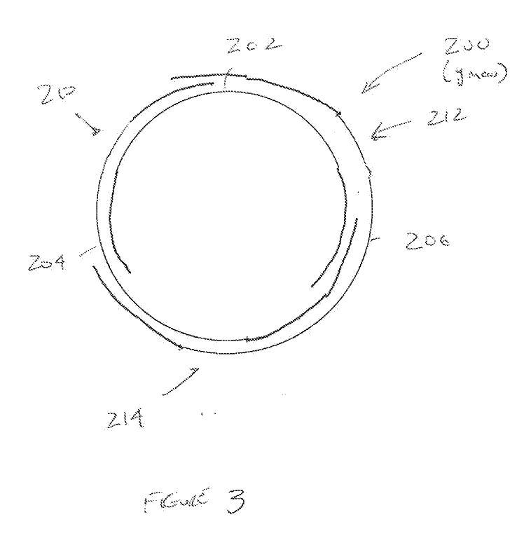

For example, FIG. 3 is a visual representation of the exemplary set of projection data 200 that may be acquired at 102 when scanning at an angular range of approximately 180 degrees plus the scan angle. The projection data 200 includes a first subset 202 of conjugate projection data acquired over a scan angle of approximately 180 degrees plus the fan angle, a second subset 204 of conjugate projection data acquired over a scan angle of approximately 180 degrees plus the fan angle, and a third subset 206 of conjugate projection data acquired over a scan angle of approximately 180 degrees plus the fan angle. In the exemplary embodiment, because projection data is acquired for each 180 degree segment plus the fan angle, the three conjugate data subsets 202, 204, and 206 will include overlapping projection data at certain points that represents the additional projection data acquired based on the fan angle of the x-ray source. For example, the subset 202 overlaps the subset 204 at a region 210, the subset 202 overlaps the subset 206 at a region 212, and the subset 204 overlaps the subset 206 at a region 214. It should be realized that, in the exemplary embodiment, the subsets 202, 204, and 206 represent different cardiac phases.

Referring again to FIG. 1, at 104 an initial reconstruction of the projection data 200 is performed to generate a plurality of images, wherein each image represents a different cardiac phase. For example, assuming that the projection data 200 is acquired for (2·N−1) phases, an image is reconstructed for each of the (2·N−1) phases. In the exemplary embodiment, the projection data 200 is acquired for three cardiac phases, represented by the conjugate projection data subsets 202, 204, and 206. In operation, the conjugate data 202 is used to reconstruct an image 250, the conjugate data 204 is used to reconstruct an image 252, and the conjugate data 206 is used to reconstruct an image 254 shown in FIGS. 1 and 2A. The images 250, 254, and 256 are referred to herein as initial images. It should be realized that in one embodiment, the initial images 250, 252, and 254 may be viewable by an operator. Optionally, the initial images 250, 254, and 256 are not visible by the operator, but rather are volumetric data that is utilized to perform the various embodiments described herein. It should also be realized that although various embodiments describe three initial images that are reconstructed using projection data acquired over approximately 180 degrees plus the fan angle, that more than three initial images, acquired over different scan angles, may be utilized to perform the methods described herein.

The projection data 200 may be used to reconstruct the initial images 250, 254, and 256 using one or more reconstruction techniques, such as, but not limited to, a short-scanning technique, a half scanning technique, a Feldkamp-Davis-Kress (FDK) reconstruction technique, tomography-like reconstructions, iterative reconstructions, a reconstruction using optimally weighted over-scan data comprising the fan angle of the x-ray beam (Butterfly reconstruction), or combinations thereof, among others.

At 106, a thresholding operation is applied to the reconstructed images formed at 104 . In one embodiment, a hard thresholding operation is performed on the initial images 250, 252, and 254 to generate a plurality of contrast images 260, 262, and 264, respectively, that identify areas of contrast from which motion artifacts originate. For example, in operation, the thresholding operation is performed on the initial image 250 such that the only non-zero contributions in the contrast image 260 are above a given Hounsfield Unit (HU) threshold. More specifically, the source of the motion artifacts within the initial image 250 are isolated using the thresholding operation to generate the contrast image 260. Moreover, the thresholding operation is performed on the initial image 252 to generate the contrast image 262 and the thresholding operation is performed on the initial image 254 to generate the contrast image 264.

The source of the artifacts are isolated using a pixel intensity threshold operation. Accordingly, in the exemplary embodiment, pixels having intensity below a predetermined threshold are isolated and removed from the initial images 250, 252, and 254 to generate the contrast images 260, 262, and 264, respectively. In one embodiment, the predetermined HU threshold is between 150 Hu and 250 HU. In the exemplary embodiment, the predetermined HU threshold is approximately 200 HU. Accordingly, after the thresholding operation is completed at step 106, the resultant contrast images 260, 262, and 264 include visual information of the bones, the injected contrast agent, and foreign material, such as for example, implanted metal devices because these substances all have a relatively high contrast relative to tissue.

In another embodiment, a soft thresholding operation is performed at 106. In operation, the soft thresholding dampens the projection data around the selected HU threshold. For example, the predetermine threshold may be set to 200 HU for a region of interest and a value of less than the predetermined threshold for areas proximate to the region of interest. The thresholds described herein may be manually input by the operator. In the exemplary embodiment, the predetermined thresholds are input into the module 530, based on a priori information. In another embodiment, the threshold is automatically selected on a case-by-case basis, based on information in the image such as the average contrast enhancement, the maximum contrast enhancement, etc. The module 530 is then configured to automatically perform the thresholding operation based on the thresholds programmed into the module 530. In the exemplary embodiment, steps 102-108 are utilized to model the motion artifacts within the image data 200. More specifically, steps 102-108 implement a forward model that is used to generate a plurality of contrast images 260, 262, and 264 which simulate the motion artifacts in the image data 200.

Referring again to FIG. 1, at 108 the thresholded contrast images 260, 262, and 264 are transformed into a conjugate domain. For example, in one embodiment, a Fast Fourier Transform (FFT) is applied to the contrast images 260, 262, and 264 to generate respective sets of data 270, 272, and 274. Thus, the contrast images 260, 262, and 264 are transformed from the image domain to the Fourier domain. The native coordinates refer to the original projection data. For example, the projection data 200 may be arranged in projection space or in Radon space, for example. In the exemplary embodiment, the FFT is performed on each contrast image 260, 262, and 264 to generate the respective FFT datasets 270, 272, and 274.

At 110, the FFT datasets 270, 272, and 274 are combined, or blended, using a smoothing operation to generate a set of conjugate domain representations 280. More specifically, and referring again to FIG. 3, the initial conjugate data subsets 202, 204, and 206 each overlap at the regions 210, 212, and 214, respectively. Accordingly, in the exemplary embodiment, the conjugate data 202, in the overlap region 210, is blended with the conjugate data 204, also located in the overlap region 210. Moreover, the conjugate data 202, in the overlap region 212, is blended with the conjugate data 206, also located in the overlap region 212. Finally, the conjugate data 204, in the overlap region 214, is blended with the conjugate data 206, also located in the overlap region 216. In use, the blending operation facilitates generating the conjugate domain representations 280 that represents substantially all of the motion evoked imaging artifacts in the image dataset 200.

Referring again to FIG. 1, at 112 the conjugate domain representations 280 generated at 110 are transformed back to the image domain. In the exemplary embodiment, the conjugate domain representations 280 are transformed to the image domain using an Inverse Fourier Transform (IFFT) to reconstruct a single image 290, also referred to herein as a forward motion model 290. In the exemplary embodiment, the forward model 290 is a contrast image that provides a visual indication of the motion evoked imaging artifacts in the image dataset 200. In the exemplary embodiment, the forward model 290 may be reconstructed using, for example, a Parker weighted filtered back projection. As such, the forward model 290 includes the motion evoked artifacts (hyper/hypo myocardial values) caused by inconsistencies in the high contrast object throughout the scan.

At 114, the contrast image 262 is subtracted from the forward model 290 to generate a residual image 300. For example, and referring again to FIG. 2B, the forward model 290 represents the motion evoked artifacts for the imaging data 200. Moreover, the contrast image 260 represents the thresholded image that includes contrast contributions that are above the predetermined contrast threshold. As a result, the residual image 300 represents the difference between the reconstruction incorporating changing contrast, i.e. image 292, and the reconstruction of the contrast at a single phase, i.e. the image 262.

At 116, a low pass filter is applied to the residual image 300 prior to proceeding to step 118. Optionally, the low pass filter is not applied to the residual image 300 and the residual image 300 is used directly in step 118.

At 118, and in one embodiment, the residual image 300 is subtracted from the initial image 252 to generate a final output image 310. The final output image 310 is a visual representation of the image generated using the conjugate data 202 with the motion evoked imaging artifacts removed as shown in FIG. 2B. It should be realized that in the exemplary embodiment, that the initial set of images that represent the conjugate data 202, 204, and 206. Thus, the final image represents the image 300 subtracted from the middle blended image 252. However, it should be realized that the methods described herein may be iteratively implemented to remove the motion evoked artifacts for the middle images in the set of initial images. For example, assuming that the initial set of images includes five images, the methods described herein may be iteratively implemented to identify the motion related imaging artifacts in the middle three images. The middle three images may then be blended to form the residual image 300 that is processed as described above. While it would be preferable to have five images for iteration, the iterations may be done on the middle image. For example, if three images, then the middle image is used. Moreover, if five images, the middle image is still used.

In another exemplary embodiment, the final image 310 may be generated by subtracting the residual image 300 from an image 320, also referred to herein as a Fourier Image Deblurring (FID) image. In the exemplary embodiment, the image 320 is a reconstructed image wherein the motion evoked image artifacts have been compensated for in a specific region of interest. For example, to generate the image 320, the operator selects, or an automatic program segment selects, one or more regions of interest, for example, the arteries in the heart. Motion evoked imaging artifacts are then determined. The motion evoked imaging artifacts are then subtracted from an initial image to generate the image 320.

Accordingly, and referring again to FIG. 1, when the image 300 is subtracted from the image 320, the final output image 310 includes motion compensation specifically for a specific region of interest. Moreover, because the methods described herein provide motion artifact reduction for the entire image. The final output image 310 includes improved artifact reduction for the entire image. However, since the motion model using an FID is more advanced in the regions where FID has been applied, no changes are made to the final image 310 in the specific region of interest.

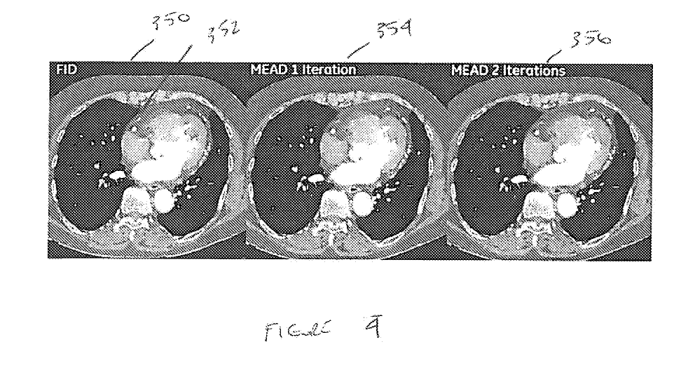

For example, FIG. 4 includes a first exemplary image 350 that was reconstructed using motion compensation applied to a specific predetermined region of interest 352. In this example, the predetermined region of interest encapsulates the artery. Moreover, image 354 illustrates the improvement to the image 352 after a single iteration of the various methods described herein. Moreover, image 356 illustrates the improvement to the image 352 after two iterations of the various methods described herein.

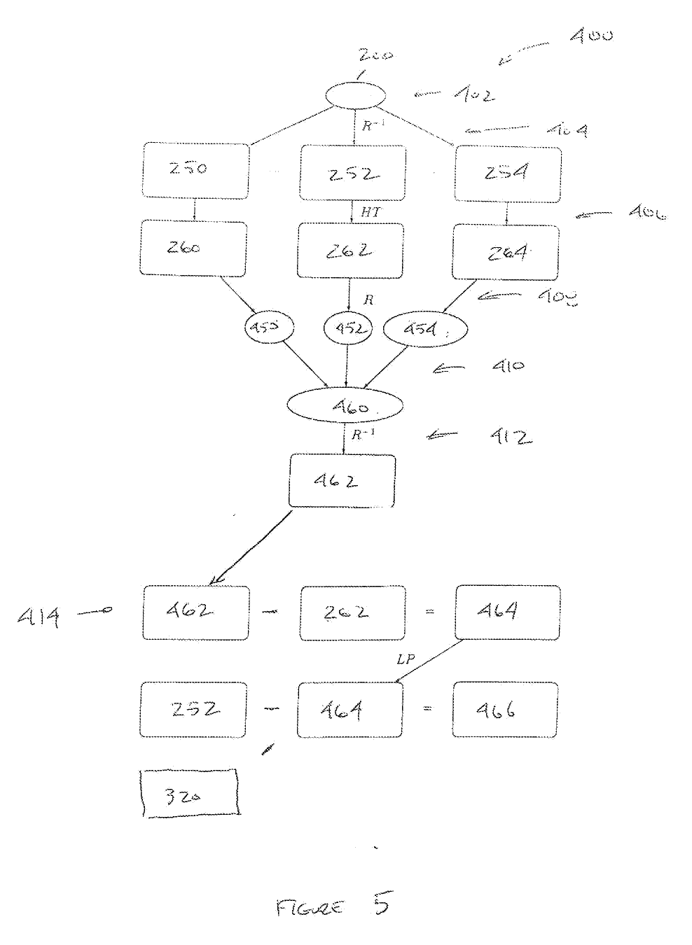

FIG. 5 is a flowchart of an exemplary method 400 for reconstructing an image of an object, such as a cardiac image of the subject 16, having reduced motion artifacts. Method 400 is substantially similar to method 100 and includes scanning at 402 the subject 16 to generate the set of data 200.

At 404, an initial reconstruction of the projection data 200 is performed to generate a plurality of images, wherein each image represents a different cardiac phase. For example, assuming that the projection data 200 is acquired for (2·N−1) phases, an image f-N is then reconstructed for each of the (2·N−1) phases. In the exemplary embodiment, the projection data 200 is acquired for the three cardiac phases, 202, 204, and 206.

At 406, a thresholding operation is applied to the reconstructed images formed at 104 to form the contrast images 260, 262, and 264, as discussed above.

At 408 a forward projection operation, also referred to as a Radon transform operation, is performed on the contrast images 260, 262, and 264 to generate a respective set of data 450, 452, and 454.

At 410, the Radon transformed datasets 450, 452, and 454 are blended, or combined, using a smoothing operation to generate a single dataset 460.

At 412 an Inverse Radon Transform is performed on the blended dataset 460 to reconstruct a single image 462, also referred to herein a forward motion model 462. In the exemplary embodiment, the model 462 is a contrast image that provides a visual indication of the motion evoked imaging artifacts in the image dataset 200. In the exemplary embodiment, the model 462 may be reconstructed using, for example, a Parker weighted filtered back projection. As such, the model 462 includes the motion evoked artifacts (hyper/hypo myocardial values) caused by inconsistencies in the high contrast object throughout the scan.

At 414, the contrast image 262 is subtracted from the model 462 to generate a residual image 464. As a result, the residual image 464 represents the difference between the reconstruction incorporating changing contrast, i.e. model 462, and the reconstruction of the contrast at a single phase, i.e. the image 262.

At 416, a low pass filter is applied to the residual image 464.

At 418, and in one embodiment, the residual image 464 is subtracted from the initial image 252 to generate a final output image 464. Optionally, the residual image may be subtracted from the image 320 as described above.

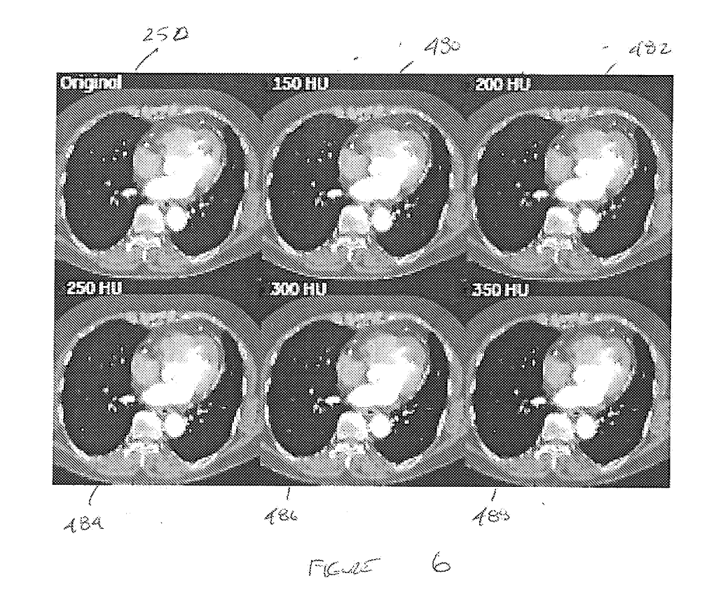

FIG. 6 is a plurality of exemplary images that may be generated using the various embodiments described herein. More specifically, the exemplary images are acquired using the method 100 shown in FIG. 1. As discussed above with respect to FIG. 1, a thresholding operation is applied to the reconstructed images formed at 104. In operation, the thresholding operation is performed on the image 250 such that the only non-zero contributions in the contrast image 260 are above a given Hounsfield Unit (HU) threshold. Accordingly, the image 250 is the initial image. The image 480 is the final output image reconstructed in accordance with various embodiments described herein wherein the predetermined threshold is set to 150 HU. The image 482 is final output image reconstructed in accordance with various embodiments described herein wherein the predetermined threshold is set to 200 HU. The image 484 is final output image reconstructed in accordance with various embodiments described herein wherein the predetermined threshold is set to 250 HU. The image 486 is final output image reconstructed in accordance with various embodiments described herein wherein the predetermined threshold is set to 300 HU. The image 488 is final output image reconstructed in accordance with various embodiments described herein wherein the predetermined threshold is set to 350 HU. Accordingly, FIG. 6 illustrates the various motion compensation results when the HU is varied based on the organ being imaged.

A technical effect of at least one embodiment described herein is to correct for the areas of false hyper-attenuation and hypo-attenuation, in the myocardium, which are caused by changes in the contrast throughout the acquisition time window.

FIG. 7 is a pictorial view of an exemplary imaging system 500 that is formed in accordance with various embodiments. FIG. 8 is a block schematic diagram of a portion of the multi-modality imaging system 500 shown in FIG. 7. Although various embodiments are described in the context of an exemplary dual modality imaging system that includes a computed tomography (CT) imaging system and a positron emission tomography (PET) imaging system, it should be understood that other imaging systems capable of performing the functions described herein are contemplated as being used.

The multi-modality imaging system 500 is illustrated, and includes a CT imaging system 502 and a PET imaging system 504. The imaging system 500 allows for multiple scans in different modalities to facilitate an increased diagnostic capability over single modality systems. In one embodiment, the exemplary multi-modality imaging system 500 is a CT/PET imaging system 500. Optionally, modalities other than CT and PET are employed with the imaging system 500. For example, the imaging system 500 may be a standalone CT imaging system, a standalone PET imaging system, a magnetic resonance imaging (MRI) system, an ultrasound imaging system, an x-ray imaging system, and/or a single photon emission computed tomography (SPECT) imaging system, interventional C-Arm tomography, CT systems for a dedicated purpose such as extremity or breast scanning, and combinations thereof, among others.

The CT imaging system 502 includes a gantry 510 that has an x-ray source 512 that projects a beam of x-rays toward a detector array 514 on the opposite side of the gantry 510. The detector array 514 includes a plurality of detector elements 516 that are arranged in rows and channels that together sense the projected x-rays that pass through an object, such as the subject 506. The imaging system 500 also includes a computer 520 that receives the projection data from the detector array 514 and processes the projection data to reconstruct an image of the subject 506. In operation, operator supplied commands and parameters are used by the computer 520 to provide control signals and information to reposition a motorized table 522. More specifically, the motorized table 522 is utilized to move the subject 506 into and out of the gantry 510. Particularly, the table 522 moves at least a portion of the subject 506 through a gantry opening 524 that extends through the gantry 510.

The imaging system 500 also includes a Motion Evoked Artifact Deconvolution (MEAD) module 530 that is configured to implement various motion compensation methods described herein. For example, the module 530 may be configured to mitigate or reduce motion related imaging artifacts in a medical image by correcting for a change in the contrast enhanced regions of the medical image. In general, the module 530 implements a deconvolution operation on the acquired images to remove motion related artifacts which may result in hyper-attenuation or hypo-attenuation that are caused by changes in the contrast throughout the image acquisition time window. For example, when applied to a cardiac image, the module 530 facilitates correcting motion related imaging artifacts in both the ventricles and the surrounding myocardium. The various methods described herein may be applied to reduce other types of motion artifacts such as, for example, bowel motion or respiratory motion.

The module 530 may be implemented as a piece of hardware that is installed in the computer 520. Optionally, the module 530 may be implemented as a set of instructions that are installed on the computer 520. The set of instructions may be stand alone programs, may be incorporated as subroutines in an operating system installed on the computer 520, may be functions in an installed software package on the computer 520, and the like. It should be understood that the various embodiments are not limited to the arrangements and instrumentality shown in the drawings.

As discussed above, the detector 514 includes a plurality of detector elements 516. Each detector element 516 produces an electrical signal, or output, that represents the intensity of an impinging x-ray beam and hence allows estimation of the attenuation of the beam as it passes through the subject 506. During a scan to acquire the x-ray projection data, the gantry 510 and the components mounted thereon rotate about a center of rotation 540. FIG. 8 shows only a single row of detector elements 516 (i.e., a detector row). However, the multislice detector array 514 includes a plurality of parallel detector rows of detector elements 516 such that projection data corresponding to a plurality of slices can be acquired simultaneously during a scan.

Rotation of the gantry 510 and the operation of the x-ray source 512 are governed by a control mechanism 542. The control mechanism 542 includes an x-ray controller 544 that provides power and timing signals to the x-ray source 512 and a gantry motor controller 546 that controls the rotational speed and position of the gantry 510. A data acquisition system (DAS) 548 in the control mechanism 542 samples analog data from detector elements 516 and converts the data to digital signals for subsequent processing. For example, the subsequent processing may include utilizing the module 530 to implement the various methods described herein. An image reconstructor 550 receives the sampled and digitized x-ray data from the DAS 548 and performs high-speed image reconstruction. The reconstructed images are input to the computer 520 that stores the image in a storage device 552. Optionally, the computer 520 may receive the sampled and digitized x-ray data from the DAS 548 and perform various methods described herein using the module 530. The computer 520 also receives commands and scanning parameters from an operator via a console 560 that has a keyboard. An associated visual display unit 562 allows the operator to observe the reconstructed image and other data from computer.

The operator supplied commands and parameters are used by the computer 520 to provide control signals and information to the DAS 548, the x-ray controller 544 and the gantry motor controller 546. In addition, the computer 520 operates a table motor controller 564 that controls the motorized table 522 to position the subject 506 in the gantry 510. Particularly, the table 522 moves at least a portion of the subject 506 through the gantry opening 524 as shown in FIG. 7.

Referring again to FIG. 8, in one embodiment, the computer 520 includes a device 570, for example, a floppy disk drive, CD-ROM drive, DVD drive, magnetic optical disk (MOD) device, or any other digital device including a network connecting device such as an Ethernet device for reading instructions and/or data from a computer-readable medium 572, such as a floppy disk, a CD-ROM, a DVD or an other digital source such as a network or the Internet, as well as yet to be developed digital means. In another embodiment, the computer 520 executes instructions stored in firmware (not shown). The computer 520 is programmed to perform functions described herein, and as used herein, the term computer is not limited to just those integrated circuits referred to in the art as computers, but broadly refers to computers, processors, microcontrollers, microcomputers, programmable logic controllers, application specific integrated circuits, and other programmable circuits, and these terms are used interchangeably herein.

In the exemplary embodiment, the x-ray source 512 and the detector array 514 are rotated with the gantry 510 within the imaging plane and around the subject 506 to be imaged such that the angle at which an x-ray beam 574 intersects the subject 506 constantly changes. A group of x-ray attenuation measurements, i.e., projection data, from the detector array 514 at one gantry angle is referred to as a “view”. A “scan” of the subject 506 comprises a set of views made at different gantry angles, or view angles, during one revolution of the x-ray source 512 and the detector 514. In a CT scan, the projection data is processed to reconstruct an image that corresponds to a two dimensional slice taken through the subject 506.

Exemplary embodiments of a multi-modality imaging system are described above in detail. The multi-modality imaging system components illustrated are not limited to the specific embodiments described herein, but rather, components of each multi-modality imaging system may be utilized independently and separately from other components described herein. For example, the multi-modality imaging system components described above may also be used in combination with other imaging systems.

As used herein, the term “computer” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”. The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software, which may be a non-transitory computer readable medium. Further, the software may be in the form of a collection of separate programs, a program module within a larger program or a portion of a program module. The software also may include modular programming in the form of object-oriented programming. The processing of input data by the processing machine may be in response to user commands, or in response to results of previous processing, or in response to a request made by another processing machine.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Also as used herein, the phrase “reconstructing an image” is not intended to exclude embodiments of the present invention in which data representing an image is generated, but a viewable image is not. Therefore, as used herein the term “image” broadly refers to both viewable images and data representing a viewable image. However, many embodiments generate, or are configured to generate, at least one viewable image.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for reconstructing an image of an object having reduced motion artifacts, said method comprising:
reconstructing a set of initial images using acquired data;
performing a thresholding operation on the set of initial images to generate a set of contrast images that identify areas of contrast from which motion artifacts originate;
transforming the thresholded images into a conjugate domain;
combining the conjugate domain representations of the contrast images;
transforming the combined conjugate domain representations to an image domain to generate a residual image; and
using the residual image to generate a final image of the object.

2. The method of claim 1, further comprising:
transforming the thresholded images into a conjugate domain using a Fast Fourier Transfer (FFT); and
transforming the conjugate domain representations to an image domain using an Inverse Fast Fourier Transfer (IFFT) to generate the residual image.

3. The method of claim 1, further comprising:
transforming the thresholded images into a conjugate domain using a forward projection technique; and
transforming the conjugate domain representations to an image domain using a filtered backprojection technique to generate the residual image.

4. The method of claim 1, wherein the object comprises a heart.

5. The method of claim 1, wherein the set of initial images comprises at least three images, a portion of a first imaging overlapping with a portion of a second image and a third image.

6. The method of claim 1, further comprising subtracting the residual image from an initial image to generate the final image.

7. The method of claim 1, wherein transforming the combined conjugate domain representations to an image domain further comprises subtracting the thresholded image from the conjugate domain representations of the contrast images to generate the residual image.

8. The method of claim 1, further comprising subtracting the residual image from a FID image to generate the final image.

9. The method of claim 1, further comprising:
performing a low-pass filter operation of the residual image; and
subtracting the filtered residual image from an initial image to generate the final image.

10. An imaging system comprising:
a detector array; and
a Motion Evoked Artifact Deconvolution (MEAD) module coupled to the detector array, the MEAD module configured to:
reconstruct a set of initial images using acquired data;
perform a thresholding operation on the set of initial images to generate a set of contrast images that identify areas of contrast from which motion artifacts originate;
transform the thresholded images into a conjugate domain;
combine the conjugate domain representations of the contrast images;
transform the combined conjugate domain representations to an image domain to generate a residual image; and
use the residual image to generate a final image of the object.

11. The imaging system of claim 10, wherein the MEAD module is further configured to:
transform the thresholded images into a conjugate domain using a Fast Fourier Transfer (FFT); and
transform the conjugate domain representations to an image domain using an Inverse Fast Fourier Transfer (IFFT) to generate the residual image.

12. The imaging system of claim 10, wherein the MEAD module is further configured to:
transform the thresholded images into a conjugate domain using a forward projection technique; and
transform the conjugate domain representations to an image domain using a filtered backprojection technique to generate the residual image.

13. The imaging system of claim 10, wherein the MEAD module is further configured to subtract the residual image from an initial image to generate the final image.

14. The imaging system of claim 10, wherein the MEAD module is further configured to subtract the thresholded image from the conjugate domain representations of the contrast images to generate the residual image.

15. The imaging system of claim 10, wherein the MEAD module is further configured to subtract the residual image from a FID image to generate the final image.

16. The imaging system of claim 10, wherein the MEAD module is further configured to:
perform a low-pass filter operation of the residual image; and
subtract the filtered residual image from an initial image to generate the final image.

17. A non-transitory computer readable medium being programmed to instruct a computer to:
reconstruct a set of initial images using acquired data;
perform a thresholding operation on the set of initial images to generate a set of contrast images that identify areas of contrast from which motion artifacts originate;
transform the thresholded images into a conjugate domain;
combine the conjugate domain representations of the contrast images; and
transform the combined conjugate domain representations to an image domain to generate a residual image; and
use the residual image to generate a final image.

18. The non-transitory computer readable medium of claim 17, further programmed to instruct a computer to:
transform the thresholded images into a conjugate domain using a Fast Fourier Transfer (FFT); and
transform the conjugate domain representations to an image domain using an Inverse Fast Fourier Transfer (IFFT) to reconstruct the final image of the object.

19. The non-transitory computer readable medium of claim 17, further programmed to instruct a computer to:
transform the thresholded images into a conjugate domain using a forward projection technique; and
transform the conjugate domain representations to an image domain using a filtered backprojection technique.

20. The non-transitory computer readable medium of claim 17, further programmed to instruct a computer to subtract the residual image from an initial image to generate the final image.
